(19) United States
(12) Patent Application Publication
(10) Pub. No.: US 2014/0157321 A1
(43) Pub. Date: Jun. 5, 2014

(54) INFORMATION PROCESSING APPARATUS, INFORMATION PROCESSING METHOD, AND COMPUTER READABLE MEDIUM

(71) Applicant: KABUSHIKI KAISHA TOSHIBA, TOKYO (JP)

(72) Inventor: Yukihiro Kurita, Kokubunji-shi (JP)

(21) Appl. No.: 13/925,100

(22) Filed: Jun. 24, 2013

(30) Foreign Application Priority Data
Nov. 30, 2012 (JP) 2012-263491

(51) Int. Cl. H04N 21/485

(52) U.S. Cl. CPC H04N 21/4858
USPC 725/47

(57) ABSTRACT

According to one embodiment, an information processing apparatus includes a display controller displaying, in a region, a text including a plurality of characters and a processor changing a display magnification in response to user operation. The processor enlarges a character size of a text displayed in the region in correspondence with an increase in the display magnification, if the character size or the display magnification is less than a threshold value, and increases number of characters of a text displayed in the region in correspondence with an increase in the display magnification, if the character size or the display magnification is greater than or equal to the threshold value.

### CROSS-REFERENCE TO RELATED APPLICATIONS

This application is based upon and claims the benefit of priority from Japanese Patent Application No. 2012-263491, filed Nov. 30, 2012; the entire contents of which are incorporated herein by reference.

### FIELD

Embodiments described herein relate generally to displaying a text in a predetermined region.

### BACKGROUND

Recent years have seen the emergence of televisions which receive electronic program guide (EPG) data, and display electronic program guides. In addition, in recent years, there has been a tendency to equip some personal computers, tablet computers, and smartphones with television tuners, allowing users to view television programs. These information processing devices sometimes display electronic program guides.

In displaying an electronic program guide in Japan, for example, channels are assigned to the horizontal line of the screen, and the time is assigned to the vertical line of the screen, to arrange the program frames in a two-dimensional manner. In a screen which is long from side to side, the number of channels displayed in the horizontal direction is about 5 to 8. With respect to the time displayed in the vertical direction, programs for 5 to 8 hours are displayed. Therefore, although program information of many programs can be displayed simultaneously, the character size of program information which is displayed in one program frame is small. Therefore, there is demand for enlarging the display freely. The demand also occurs if a text is displayed in a region, as well as display of the electronic program guide.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an example of an external appearance of an information processing apparatus according to an embodiment.

FIG. 2 is a block diagram of an example of internal configuration of the information processing apparatus according to the embodiment.

FIG. 3 is a diagram illustrating an example of flow of program guide enlargement/reduction processing performed by the information processing apparatus according to the embodiment.

FIG. 4 is a diagram illustrating an example of an electronic program guide displayed by the information processing apparatus according to the embodiment.

FIG. 5 is a diagram illustrating an example of enlargement of display of the electronic program guide according to the embodiment.

FIG. 6 is a diagram illustrating another example of enlargement of display of the electronic program guide according to the embodiment.

FIG. 7 is a diagram illustrating an example of flow of program guide enlargement/reduction processing performed by an information processing apparatus according to a second embodiment.

FIG. 8 is a diagram illustrating an example of flow of processing performed by an information processing apparatus and a server system according to a third embodiment.

### DETAILED DESCRIPTION

Various embodiments will be described hereinafter with reference to the accompanying drawings.

In general, according to one embodiment, an information processing apparatus includes a display controller displaying, in a region, a text comprising a plurality of characters, and a processor changing a display magnification in response to user operation. The processor enlarges a character size of a text displayed in the region in correspondence with an increase in the display magnification, if the character size or the display magnification is less than a threshold value, and increases number of characters of a text displayed in the region in correspondence with an increase in the display magnification, if the character size or the display magnification is greater than or equal to the threshold value.

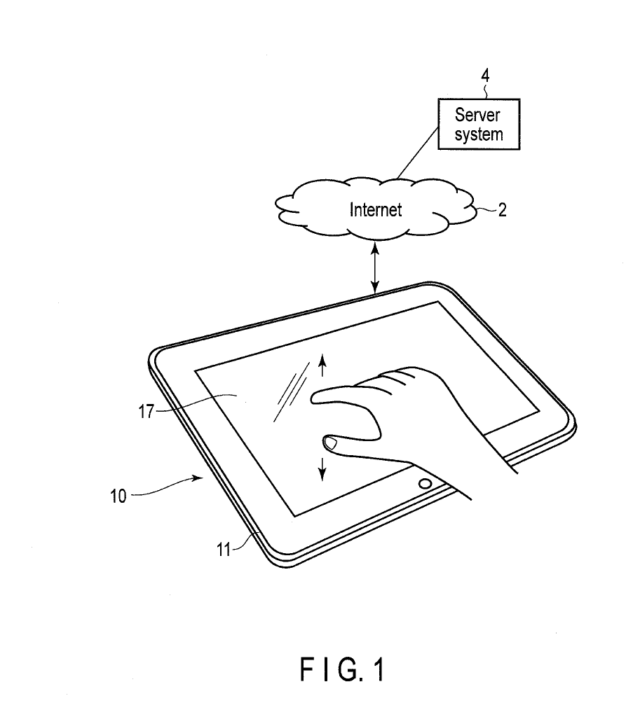

FIG. 1 is a diagram illustrating an external appearance of an information processing apparatus 10 according to an embodiment. The information processing apparatus 10 is realized by, a tablet computer, a note book personal computer, a smartphone, a PDA, or another information terminal, which includes a television tuner, as well as an ordinary television. The following explanation shows the case where the information processing apparatus 10 is realized as a tablet computer, for convenience.

A main body 11 includes a housing of a thin box shape. A surface of the main body 11 is provided with a touchscreen display 17. The touchscreen display 17 includes a flat panel display, and a sensor configured to sense a position in which a finger touches the screen of the flat panel display, that is, touch operation. Touch operations include tapping, double tapping, dragging, flicking, pinching, spreading and pressing. Pinching includes pinch-in in which the distance of two touch points is decreased and pinch-out in which the distance of two touch points is increased.

The flat panel display may be, for example, a liquid crystal display (LCD) device. As the sensor, it is possible to use, for example, a capacitive touchpanel. The touchpanel is provided to cover the screen of the flat panel display.

The tablet computer 10 has a network communication function, and can operate together with other personal computers and a server system 4 on the Internet 2. Specifically, the tablet computer 10 includes a wireless communication device such as a wireless LAN communication device, and can perform wireless communication with other personal computers. The tablet computer 10 can also communicate with the server system 4 on the Internet 2. The server system 4 is a system for sharing various information items, and executes various cloud computing services. The server system 4 can be formed of one or more server computers.

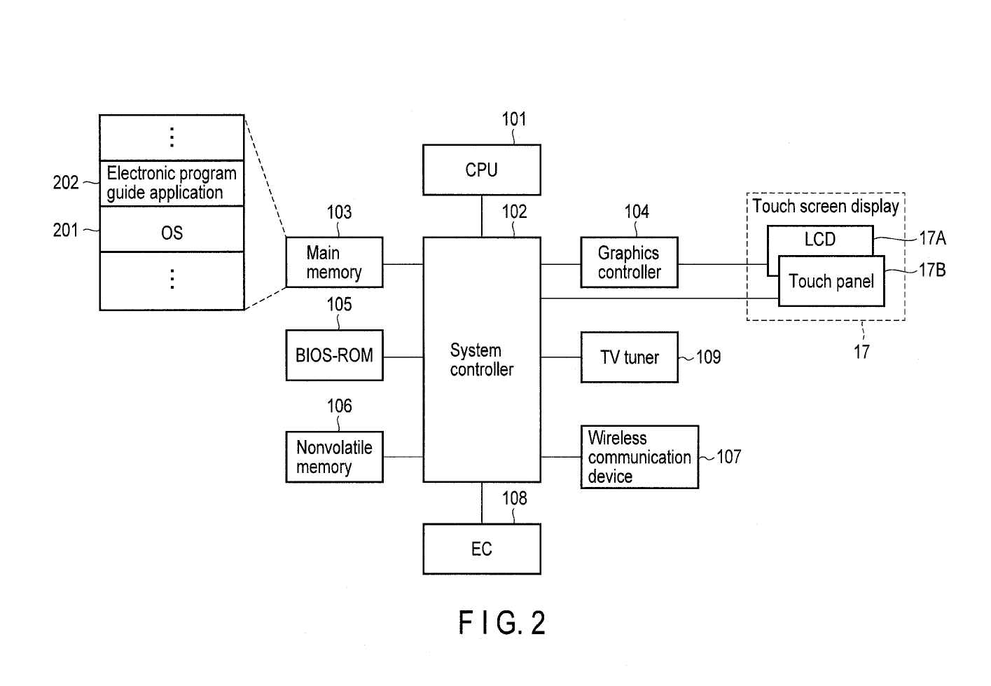

FIG. 2 is a diagram illustrating system configuration of the tablet computer 10.

The tablet computer 10 includes a CPU 101, a system controller 102, a main memory 103, a graphics controller 104, a BIOS-ROM 105, a nonvolatile memory 106, a wireless communication device 107, an embedded controller (EC) 108, and a TV tuner 109.

The CPU 101 is a processor which controls operations of the modules in the tablet computer 10. The CPU 101 executes various software programs loaded from the nonvolatile memory 106, which is a storage device, into the main memory 103. The software programs include an operating system (OS) 201, and various application programs. The application programs include an electronic program guide application program 202. The electronic program guide application program 202 has a function of displaying an electronic program guide based on the received EPG data, and a function of enlarging and reducing the program guide.

The CPU 101 also executes a basic input/output system (BIOS) which is stored in the BIOS-ROM 105. The BIOS is a program for controlling hardware.

The system controller 102 is a device which connects a local bus of the CPU 101 with various components. The system controller 102 also includes a memory controller which controls access to the main memory 103. The system controller 102 also has a function of performing communication with the graphics controller 104 through a serial bus of the PCI EXPRESS standard.

The graphics controller 104 is a display controller which controls an LCD 17A that is used as display monitor of the tablet computer 10. Display signals (television image signals and electronic program guide signals) which are generated by the graphics controller 104 are transmitted to the LCD 17A. The LCD 17A displays a screen image based on the display signal. A touchpanel 17B is disposed on the LCD 17A. The touchpanel 17B is a capacitive pointing device configured to perform input on the screen of the LCD 17A. The touchpanel 17B senses a touch position on the screen, which the user's finger touches, and movement of the touch position.

The wireless communication device 107 is a device configured to execute wireless communications such as wireless LAN communications and 3G (3rd generation) mobile communications. The EC 108 is a one-chip microcomputer which includes an embedded controller for electric power control. The EC 108 has a function of turning on and off the tablet computer 10, in response to operation of a power button by the user.

The TV tuner 109 is compliant with terrestrial digital broadcasting and one-segment broadcasting, and connected to an antenna (not shown). The antenna includes a rod antenna which is contained in the main body.

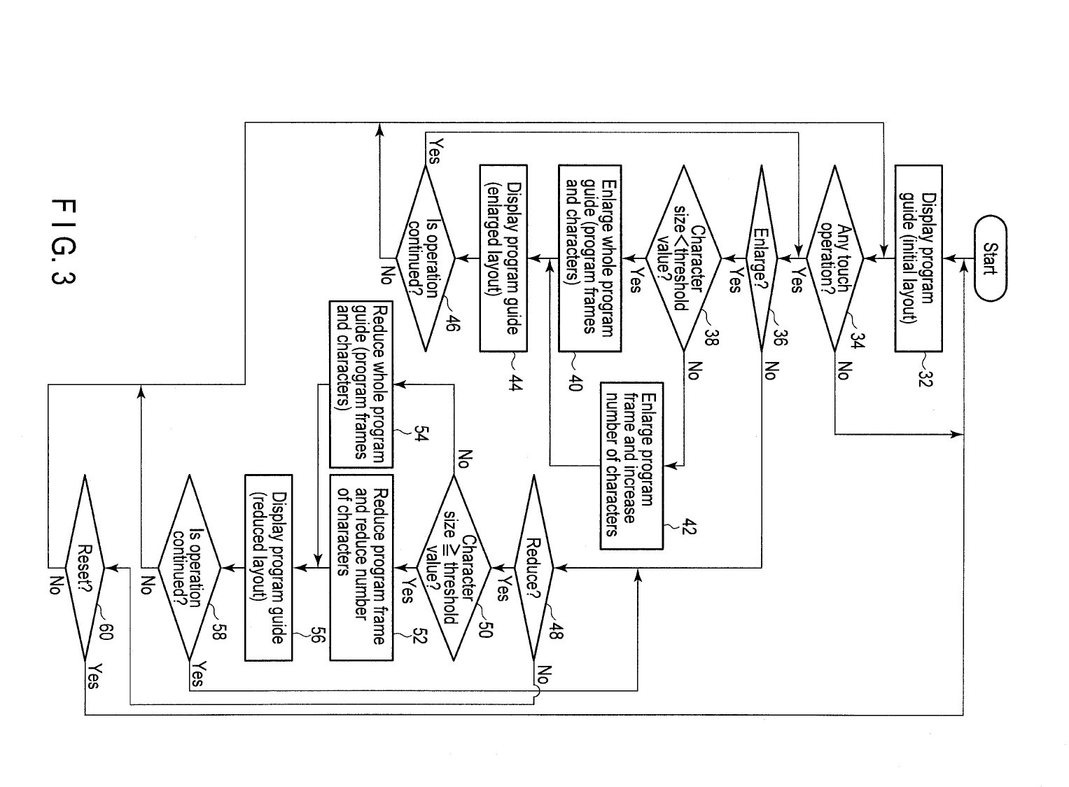

FIG. 3 is a diagram illustrating flow of processing of displaying an electronic program guide, which is performed by the electronic program guide application program 202 according to the embodiment.

After the tablet computer 10 is turned on, a start menu is displayed on the screen. If a program guide icon is selected in the start menu, an electronic program guide is displayed in Block 32. As another example, Block 32 is executed if the program guide icon is selected from icons which are displayed around the picture while a television program is viewed.

EPG data which indicates program information is obtained in advance through broadcasting signals or a network. If the EPG data is obtained through the broadcasting signals, the EPG data is separated from the broadcasting signals received by the TV tuner 109. As another method, it is also possible to obtain the EPG data from the Internet 2 through the wireless communication device 107. The EPG data is stored in the nonvolatile memory 106.

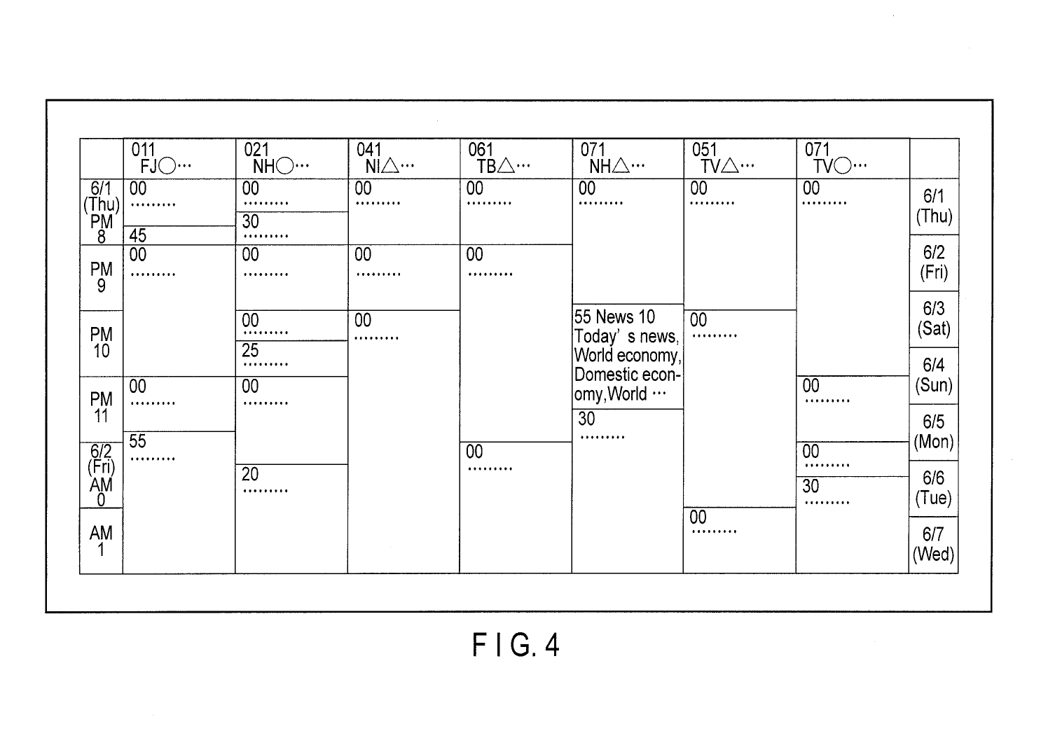

FIG. 4 illustrates an example of the electronic program guide. In the example, layout, in which the vertical line indicates the time, the horizontal line indicates the channels, and programs of 7 channels for 6 hours are arranged, is set as initial layout. The initial layout is displayed at the first time Block B32 is performed. The specific number of arranged programs is not limited to it, and the vertical line and the horizontal line may be exchanged. Specifically, 7 channel frames, each of which corresponds to one broadcasting station (channel), are arranged in the horizontal direction. Each of the upper end frames of the channel frames shows the channel number and the channel name. The left end frames indicate the time periods. The right end frames display icons of the dates for 1 week including today. If the user taps one of the date icons, the page jumps to a program guide of the tapped date. The channel frame of each channel is divided into program frames, each of which has a length that corresponds to the length of the broadcasting time of the program. The uppermost program frames in the program guide correspond to programs which are being broadcasted at present.

In the initial layout, characters of the program information are set to a preset font size (for example, 10.5 points). Therefore, if the program information includes a large number of characters, all the characters cannot be displayed in the program frame, and only the first part of the program information is displayed.

If the number of channels is larger than 7, the page can be horizontally scrolled or changed, by dragging or flicking the page horizontally. In the same manner, if the user wishes to view a program guide of the time period later the time period which is displayed at present, the page can be vertically scrolled or changed by dragging or flicking the page vertically.

The program guide of the initial layout is kept to be displayed, until touch operation on the touchpanel 17B is detected in Block 34. If touch operation is detected in Block 34, it is determined in Block 36 whether an enlargement instruction event has been detected. The enlargement instruction may be generated in response to any user operation defined by the system or the terminal. For example, the enlargement instruction may correspond to the pinch-out operation in which the user touches two points with two fingers and the distance between the two points is increased. The two fingers may touch any part of the screen, as long as the mid-point between the fingers falls within the target program frame. The pinch-out operation may be performed in any direction: horizontally, vertically, or obliquely.

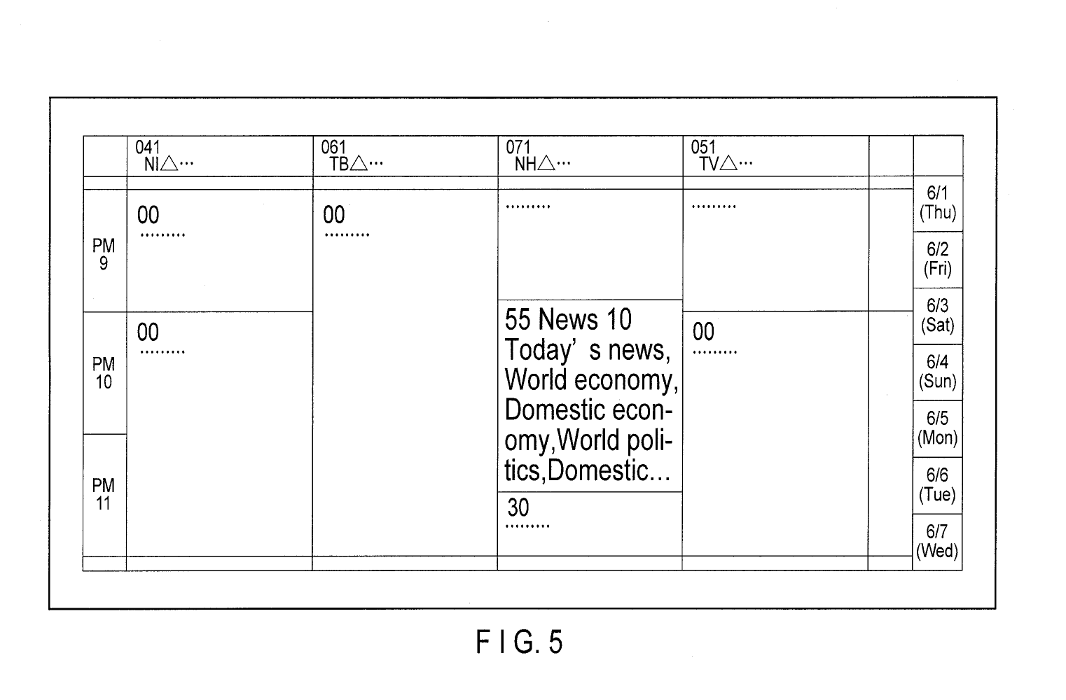

If it is determined in Block 36 that there is an enlargement instruction, it is determined in Block 38 whether the character font size is less than a predetermined threshold value (for example, 14 points) or not. If the character font size is less than the threshold value, the whole program guide is enlarged in Block 40 by the magnification which corresponds to the degree of the pinch-out operation, as illustrated in FIG. 5. As the distance between the two fingers is increased by the pinch-out operation, the magnification is gradually increased from 1.0. The current value of the magnification is stored in the nonvolatile memory 106. With increase in the magnification, the region of each program frame is enlarged, and the font size of the characters which are displayed in the program frame is also increased as the program frame is enlarged. The current value of the character font size is also stored in the nonvolatile memory 106. The same enlargement ratio is applied to the vertical direction and the horizontal direction, regardless of the direction of the pinch-out operation. Specifically, the program frame is enlarged, with the aspect ratio maintained. If the program guide is enlarged, the whole initial program guide cannot be displayed as a matter of course, and part of the program guide is displayed. In this case, the program frame and the character size are enlarged, with the middle point between the two fingers which are touching the screen serving as the center. If pinch-out operation is performed for a region located in an end part of the program guide, however, part of the program frame in the end part of the program guide goes out of the screen and cannot be displayed, if the program guide is enlarged with the middle point between the two fingers serving as the center. Therefore, the position of the center of enlargement is moved slightly inside from the middle point between the two fingers, such that the part of the program frame in the end part of the program guide falls within the picture.

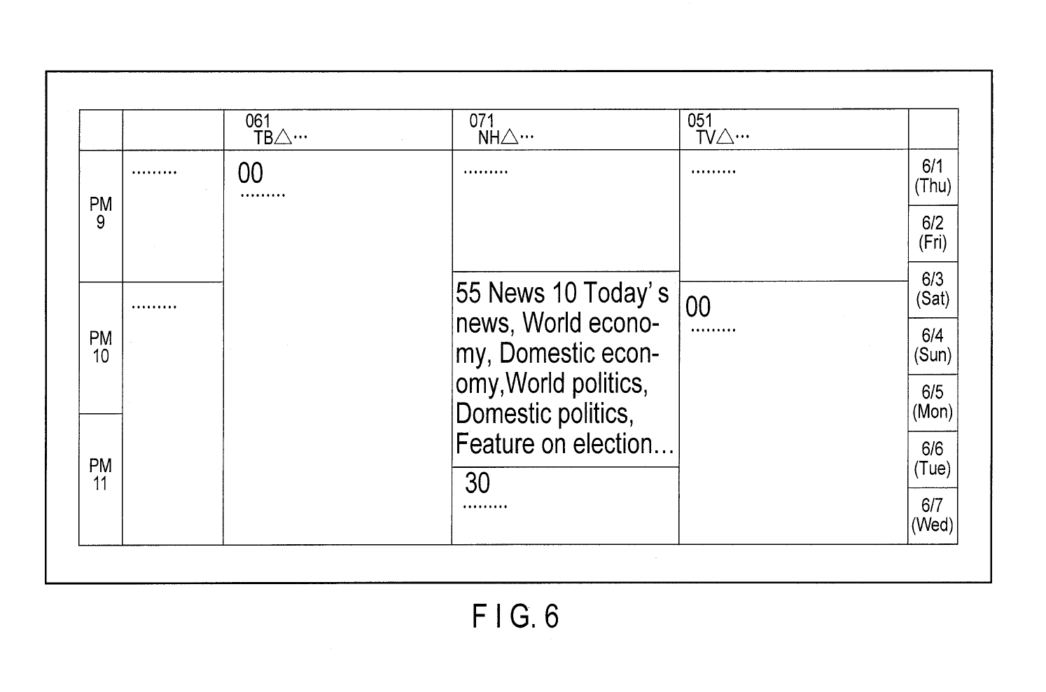

If the character font size is not less than the threshold value, the program frame is enlarged with increase of the magnification, as illustrated in FIG. 6, and the number of characters which are displayed in the program frame is increased as the program frame is enlarged. If the character font size is not less than the threshold value, it can be assumed that the characters have already been enlarged to a sufficient size. Therefore, it is unnecessary to enlarge the character font size of the characters displayed in the program frame as the program frame is enlarged. If there is room in the frame even if the number of characters is increased, the character font size may be increased. Also in this case, the program frame located in an end part of the program guide is enlarged with the end part thereof serving as the center, and the enlargement ratio corresponds to the degree of the pinch-out operation.

Specifically, from the initial state illustrated in FIG. 4 to the state illustrated in FIG. 5, the whole program guide is enlarged, and the program frame and the character size are enlarged together. Therefore, the number of displayed characters is not changed. If the character size of FIG. 5 is the threshold size, the number of displayed characters is increased with enlargement of the program frame, from the state of FIG. 5 to the state of FIG. 6. The character size may be enlarged, if required.

After Blocks 40 and 42, the layout of the program guide is fixed to the enlarged layout in Block 44. Next, in Block 46, it is determined whether the touch operation is continued or not. If the touch operation is continued, the processing is repeated from determination of Block 36, that is, determination as to whether there is an enlargement instruction. If the touch operation is ended, the processing is repeated from determination of Block 34, that is, determination as to whether there is a touch operation.

If it is determined in Block 36 that there is no enlargement instruction, it is determined in Block 48 whether a reduction instruction event has been detected or not. The reduction instruction may be generated in response to any user operation defined by the system or the terminal. For example, the reduction instruction may correspond to the pinch-in operation in which the user touches two points with two fingers and the distance between the two points is decreased. The two fingers may touch any part of the screen, as long as the mid-point between the fingers falls within the target program frame. The pinch-in operation may be performed in any direction: horizontally, vertically, or obliquely.

If it is determined that there is a reduction instruction, it is determined in Block 50 whether the character font size is greater than or equal to the predetermined threshold value. If the character font size is greater than or equal to the threshold value, the display layout is changed in Block 52 from the state illustrated in FIG. 6 to the state illustrated in FIG. 5. Specifically, if a touch operation is detected, the magnification is read from the nonvolatile memory 106, and the magnification is gradually reduced as the distance between the two fingers is narrowed by the pinch-in operation. With reduction in the magnification, each program frame is reduced, and the number of characters which are displayed in the program frame is reduced as the program frame is reduced. In the same manner as the case of enlargement, the same reduction ratio is applied to the vertical direction and the horizontal direction, regardless of the direction of the pinch-in operation. Each program frame is reduced in the state where the aspect ratio is fixed. If the program frame is reduced, the part of the program guide, which was located outside the screen and was not displayed, is displayed as a matter of course. If the pinch-in operation is performed for a region located in an end part of the program guide, a blank part which includes no program guide is generated in the end part of the picture, if the program frame is reduced with the middle point between the two fingers serving as the center. Therefore, the center position is moved slightly outside from the middle point between the two fingers.

If the character font size is less than the threshold value, the display layout is changed in Block 54 from the state illustrated in FIG. 5 to the state illustrated in FIG. 4. Specifically, the whole program table is reduced with reduction in the magnification, and the size of characters displayed in the program frame is reduced as the program frame is reduced.

After Blocks 52 and 54, the layout of the program guide is fixed to the reduced layout in Block 56. Next, it is determined in Block 58 whether the touch operation is continued or not. If the touch operation is continued, the processing is repeated from determination of Block 48, that is, determination as to whether there is a reduction instruction. If the touch operation is ended, the processing is repeated from determination of Block 34, that is, determination as to whether there are any touch operations.

If it is determined in Block 48 that there is no reduction instruction, it is determined in Block 60 whether there is a reset instruction. The reset instruction may correspond to double tapping on any point on the screen.

If it is determined that there is a reset instruction, the picture returns to display of the electronic program guide with the initial layout of Block 32. If it is determined that there is no reset instruction, the processing is repeated from determination of Block 34, that is, determination as to whether there are any touch operations.

As described above, according to the first embodiment, if there is a display enlargement instruction in the state where the electronic program guide is displayed, the character font size is detected. If the character font size is less than the threshold value, the character size of the program information displayed in the program frame is increased as the program frame is enlarged. If the character font size is greater than or equal to the threshold value, the number of characters of the program information displayed in the program frame is increased as the program frame is enlarged. First, the whole program guide is enlarged, and the program frame and the character size are enlarged together. Although the number of displayed characters is not changed, the character size is increased, and the visibility of the program frame is improved. Then, if the character size becomes greater than or equal to the threshold size, the number of characters is increased as the program frame has been enlarged. Therefore, information of a large number of characters can be viewed with a visible size, and the user experience is further improved.

If the program guide with characters of the initial size is sufficiently visible for the user, the threshold value of the character size may be set to the initial size. Thereby, it is possible to perform enlargement processing in which only the program frame is enlarged from the first and the number of characters is increased (processing in Block 40 of FIG. 3).

In many electronic program guides used at present, setting of the character size is separated from setting of the number of displayed channels (size of the program frame). According to the present embodiment, however, it is possible to dynamically optimize both of them, and the information processing apparatus is easy to use for the user.

If an instruction to reduce the display is issued, the number of characters of program information which is displayed in the program frame is reduced together with reduction of the program frame, if the character size of the program information is greater than or equal to the threshold value. If the character size of the program information is less than the threshold value, the character size of the program information displayed in the program frame is reduced together with reduction of the program frame.

Other embodiments will be explained hereinafter. In explanation of other embodiments, constituent elements which are the same as those of the first embodiment are denoted by respective reference numerals that are the same as those of the first embodiment, and detailed explanation thereof is omitted.

The information processing apparatus according to a second embodiment has the same external appearance and internal configuration as those of the first embodiment, and explanation thereof is omitted.

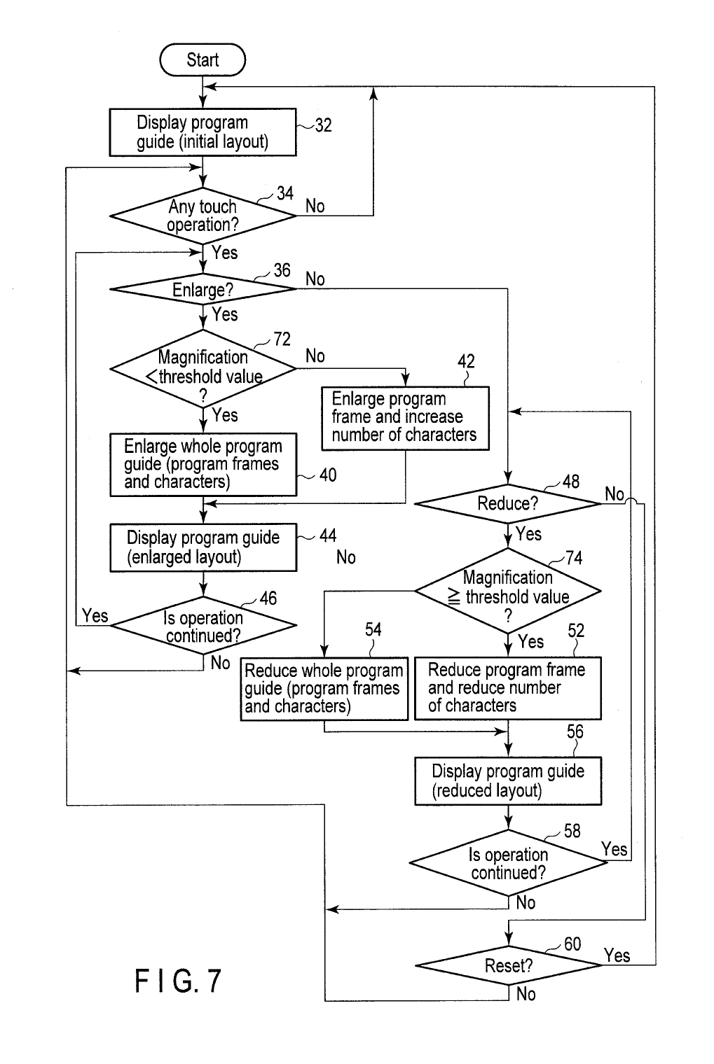

FIG. 7 is a diagram illustrating flow of processing of displaying a program guide, which is performed by an electronic program guide application program 202 of the second embodiment. Although enlargement and reduction processing of the second embodiment are almost the same as those of FIG. 3, the second embodiment is different from the first embodiment in determination criterion in which the program guide is changed from the state illustrated in FIG. 4 to the state illustrated in FIG. 5, and the program guide is changed from the state illustrated in FIG. 5 to the state illustrated in FIG. 6. Although the display is changed in the processing of FIG. 3 based on whether the character font size is less than the threshold value or not, the display may be changed based on whether the display magnification designated by pinch-out operation or pinch-in operation is less than the threshold value or not, as illustrated in Blocks 72 and 74 of FIG. 7 according to the second embodiment. The magnification of the display in FIG. 4 is 1.0. For example, the magnification of the display of FIG. 5 can be set as the threshold value. The other blocks of FIG. 7 are the same as FIG. 3.

Although the first and second embodiments show the case where all the processing is executed in the apparatus main body, it is possible to use a cloud computing service on the Internet. For example, the server system 4 may execute the processing of preparing an electronic program guide from the EPG data. Specifically, the server system 4 is equipped with a program such as the electronic program guide application program 202, and the tablet computer 10 may only display the electronic program guide received from the server system 4. In this case, since the enlargement processing is also performed by the server system 4, the tablet computer 10 only transmits an enlargement instruction to the server system 4. Then, the tablet computer 10 receives and displays the enlarged electronic program guide. In this case, if the number of characters is increased as illustrated in FIG. 6, it suffices that the tablet computer 10 receives data for the increased characters from the server system 4.

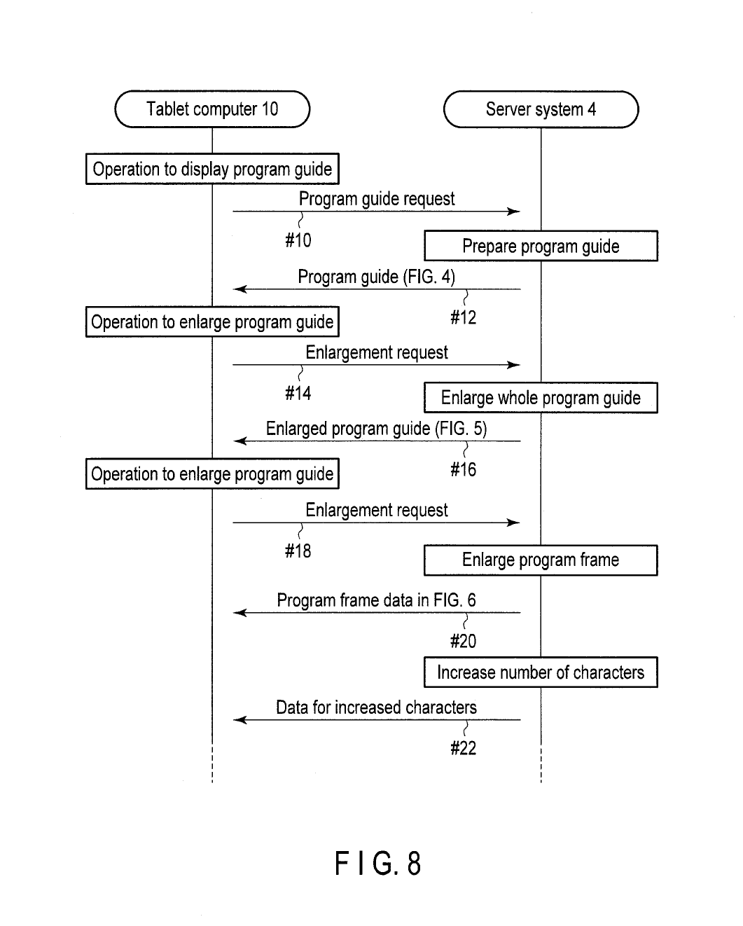

FIG. 8 illustrates flow of processing performed by the tablet computer 10 and the server system 4.

If touch operation to instruct the table computer 10 to display a program guide is performed in the tablet computer 10, the tablet computer 10 requests the server system 4 to transmit a program guide (Step #10). If the server system 4 creates layout data of the program guide, an electronic program guide of the initial layout as illustrated in FIG. 4 is transmitted from the server system 4 to the tablet computer 10 (Step #12).

If touch operation to instruct the tablet computer 10 to enlarge display of the program guide is performed in the tablet computer 10, an enlargement request is transmitted to the server system 4 (Step #14). The processing of enlarging the whole program guide as illustrated in Block 60 of FIG. 3 is finished in the server system 4, the server system 4 transmits the wholly enlarged electronic program guide as illustrated in FIG. 5 to the tablet computer 10 (Step #16).

If touch operation to instruct the tablet computer 10 to further enlarge the program guide is performed in the tablet computer 10, a request to further enlarge the program guide is transmitted to the server system 4 (Step #18). The server system 4 performs processing of enlarge the program frame with a fixed character size, as illustrated in Block 62 of FIG. 3. At Step #20, the program frame data of the program frame which has been enlarged is transmitted to the tablet computer 10 (Step #20). The server system 4 increases the number of characters displayed in the enlarged program frame, and the increased character data is transmitted to the tablet computer 10 (Step #22). Thereafter, steps #20 and #22 are repeated as long as the enlargement operation is continued.

As described above, if the number of displayed characters is increased, only data of the increased characters is transmitted from the server system 4 to the tablet computer 10, and thus the communication time can be shortened.

The following is an explanation of modifications.

The embodiment is applicable not only tablet computers which can perform touch operation, but also information processing apparatuses which perform key inputs. In the case of applying the embodiment to the latter, the enlargement instruction can be inputted by key input, or using a mouse or the like. In addition, the embodiment is also applicable to ordinary televisions. In this case, the enlargement instruction can be inputted by using a button of the remote controller.

Although the above embodiments show the example where the information processing apparatus includes the TV tuner 109, and receive broadcasting radio waves which is transmitted through the air to view broadcasting programs, the information processing apparatus may receive programs which are distributed from broadcasting stations through a cable television or a network such as an IP (Internet Protocol) network.

Although the above embodiments show the example of viewing television broadcasting in real time, the embodiment is also applicable to a recorded program table used for playing back a recorded program.

Although the electronic program guide has been explained as an example of display, the display is not limited to it, but the embodiment is applicable to any device or application, as long as it displays a text in a certain region. For example, the embodiment is applicable to browsers for viewing Web pages on the Internet, and spreadsheet applications.

The processing performed by the tablet computer 10 of the embodiments can be executed by a computer program, and thus the same effect as the embodiments can be easily obtained, only by installing the computer program in an ordinary computer through a computer-readable storage medium which stores the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. An information processing apparatus comprising:
a display controller configured to display, in a region, a text comprising a plurality of characters; and
a processor configured to change a display magnification of the display controller in response to user operation,
wherein
the processor is configured to enlarge a character size of a text displayed in the region in correspondence with an increase in the display magnification, if the character size or the display magnification is less than a threshold value, and
the processor is configured to increase number of characters of a text displayed in the region in correspondence with an increase in the display magnification, if the character size or the display magnification is greater than or equal to the threshold value.

2. The information processing apparatus of claim 1, wherein
the processor is configured to reduce the number of characters of the text displayed in the region in correspondence with a decrease in the display magnification, if the character size or the display magnification is greater than or equal to the threshold value, and
the processor is configured to reduce the character size of the text displayed in the region in correspondence with a decrease in the display magnification, if the character size or the display magnification is less than the threshold value.

3. The information processing apparatus of claim 1, further comprising a controller configured to set the threshold value, by user operation.

4. The information processing apparatus of claim 1, further comprising a touchpanel,
wherein the processor is configured to change the display magnification, if the processor detects change of a distance between two contact points on the touchpanel.

5. The information processing apparatus of claim 1, wherein the processor comprises a controller configured to change the display magnification to an initial magnification, in response to first user operation.

6. The information processing apparatus of claim 5, wherein
the display controller comprises a touchpanel, and
the controller is configured to change the display magnification to the initial magnification, in response to first touch operation on the touchpanel.

7. The information processing apparatus of claim 1, wherein the processor is configured to enlarge or reduce the region and the text, with an aspect ratio maintained.

8. The information processing apparatus of claim 1, wherein the display controller is configured to display an electronic program guide.

9. An information processing method comprising:
displaying, in a region, a text comprising a plurality of characters; and
changing a display magnification in response to user operation,
wherein the changing comprises:
enlarging a character size of a text displayed in the region in correspondence with an increase in the display magnification, if the character size or the display magnification is less than a threshold value, and
increasing number of characters of a text displayed in the region in correspondence with an increase in the display magnification, if the character size or the display magnification is greater than or equal to the threshold value.

10. A non-transitory computer-readable storage medium comprising a computer program configured to be executed by a computer comprising a display controller configured to display, in a region, a text comprising a plurality of characters, and a processor configured to change a display magnification of the display controller in response to user operation, the computer program comprising instructions configured to cause the computer to execute functions of:
enlarging a character size of a text displayed in the region in correspondence with an increase in the display magnification, if the character size or the display magnification is less than a threshold value; and
increasing number of characters of a text displayed in the region in correspondence with an increase in the display magnification, if the character size or the display magnification is greater than or equal to the threshold value.

11. An information processing system configured to receive a request from an information processing terminal comprising a display controller configured to display, in a region, a text comprising a plurality of characters, the system comprising:
a first transmitter configured to transmit first display data, comprising the text in the region, to the information processing terminal, if a display start instruction is received from the information processing terminal;
a second transmitter configured to transmit second display data comprising the region and the text that are enlarged, to the information processing terminal, if a first enlargement instruction is received from the information processing terminal configured to display the first display data; and
a third transmitter configured to enlarge the region, and to transmit third display data comprising data of the enlarged region and data for increased number of characters in response to enlargement of the region to the information processing terminal, if a second enlargement instruction is received from the information processing terminal configured to display the second display data.
